(19) United States
(12) Patent Application Publication
(10) Pub. No.: US 2025/0176675 A1
(43) Pub. Date: Jun. 5, 2025

(54) SURFACE-FASTENER-MANUFACTURING METHOD, SURFACE FASTENER, AND MOLDING DEVICE

(71) Applicants: YKK Corporation, Tokyo (JP); DYMCO, LTD., Kanagawa (JP)

(72) Inventors: Isamu Michihata, Kurobe-Shi, Toyama-Ken (JP); Wataru Kuriyama, Kurobe-Shi, Toyama-ken (JP); Yui Miyawaki, Kurobe-Shi, Toyama-ken (JP); Shoichi Yokoyama, Kurobe-Shi, Toyama-ken (JP); Kento Mitsuhashi, Kurobe-Shi, Toyama-ken (JP); Kiyonori Matsuda, Yokohama-shi, Kanagawa-ken (JP); Miho Kakiuchi, Yokohama-shi, Kanagawa-ken (JP)

(21) Appl. No.: 18/862,007

(22) PCT Filed: May 25, 2022
(86) PCT No.: PCT/JP2022/021428

§ 371 Date: Oct. 31, 2024

(51) Int. Cl. A44B 18/00; B29C 43/22; B29C 43/46; B29L 31/00

(52) U.S. Cl. CPC A44B 18/0003; B29C 43/222; B29C 43/46; B29L 2031/729

(57) ABSTRACT

A surface-fastener-manufacturing method includes at least a molding step of performing molding by feeding synthetic resin toward a die wheel, and a stretching step. The method includes using the die wheel in the molding step. The die wheel includes a sleeve having cavities. The sleeve has a circular cylindrical shape and is obtained from a metal thin plate member by bringing one end portion and an other end portion of the thin plate member into contact with each other and joining the one end portion and the other end portion to each other by welding. The welded part is inclined at an angle of 4° or greater with respect to a second direction. The method enables the manufacture of a surface fastener in which a transferred unevenness portion is less noticeable.

### TECHNICAL FIELD

The present invention relates to a surface-fastener-manufacturing method, a surface fastener, and a molding device.

### BACKGROUND ART

Hitherto known surface fastener products include a one provided as a combination of a female surface fastener (hereinafter referred to as a loop member) having a plurality of loops and a male surface fastener attachable to and detachable from the loop member. The male surface fastener includes, for example, a flat base part and a plurality of engaging elements. The engaging elements project from the base part and are each shaped like a mushroom or the like.

Currently, surface fasteners are in wide uses among various products including items to be detachably put on any part of the body: for example, disposable diapers, infant diaper covers, supporters for protecting joints of limbs and the like, waist corsets (belts for lower-back pain), gloves, and so forth. An exemplary surface fastener intended for disposable diapers and the like is disclosed in International Publication No. 2017/109902 (PTL 1).

The surface fastener disclosed in PTL 1 includes a base part and a plurality of engaging elements projecting from the base part. The engaging elements disclosed in PTL 1 each include a stem portion standing from the base part, and a disc-shaped engaging head provided integrally with the upper end of the stem portion. The engaging head has a plurality of microsized pawl portions projecting from the outer peripheral edge of the engaging head.

In the surface fastener disclosed in PTL 1, the microsized pawl portions provided at the engaging heads of the engaging elements facilitate the engagement of the loops of the loop member with the engaging elements and make it difficult for the loops once engaged to be disengaged from the engaging elements. Thus, an increased peel strength (also referred to as engaging strength) is provided to the loop member of the surface fastener. Furthermore, according to PTL 1, since the pawl portions contributing to the increase in the peel strength are provided in microsizes at the outer peripheral edges of the engaging heads, the influence of the pawl portions upon the feel of the surface fastener is reduced. Consequently, a surface fastener with an increased engaging strength and a favorable surface feel is provided.

As illustrated in FIG. 8, the surface fastener disclosed in PTL 1 is manufactured by using a manufacturing apparatus 80. The manufacturing apparatus 80 includes a molding device 81, which is configured to perform primary molding; and a hot pressing device 91, which is configured to perform secondary molding. The molding device 81 includes a die wheel 82, which is configured to rotate in one direction; a feeding nozzle 86, which is provided facing the outer peripheral surface of the die wheel 82; and a pickup roller 87, which is provided on the downstream side relative to the feeding nozzle 86 in the direction of rotation of the die wheel 82.

The die wheel 82 includes a circular cylindrical outer sleeve 83, which serves as a die; a circular cylindrical inner sleeve 84, which is provided on the inner side of and in close contact with the outer sleeve 83; and a rotatable driving roller 85, which is configured to rotate the outer sleeve 83 and the inner sleeve 84 in the one direction. The outer sleeve 83 has a plurality of through-holes each penetrating through the outer sleeve 83 from the outer peripheral surface to the inner peripheral surface thereof. The inner sleeve 84 has a plurality of recesses in the outer peripheral surface thereof.

The hot pressing device 91 includes a pair of upper and lower pressing rollers (calender rollers) 92 and 93.

To manufacture a surface fastener by using the manufacturing apparatus 80 illustrated in FIG. 8, a primary molding step is first performed in the molding device 81. In the primary molding step, molten thermoplastic resin is continuously fed from the feeding nozzle 86 onto the outer peripheral surface of the rotating die wheel 82, whereby a primary molded body is obtained that includes a base part and a plurality of primary elements provided on the base part.

Subsequently, the primary molded body thus obtained in the primary molding step is transported to the hot pressing device 91. In the hot pressing device 91, a secondary molding step is performed, in which secondary molding is performed on the primary molded body. In the secondary molding step, the primary molded body is introduced between the upper and lower pressing rollers 92 and 93, whereby the upper end portions of the primary elements are pressed to be deformed. Accordingly, engaging elements each having an engaging head with pawl portions provided at the outer peripheral edge thereof are obtained. Thus, the surface fastener disclosed in PTL 1 is manufactured.

The outer sleeve 83 and the inner sleeve 84 included in the die wheel 82 to be used in the primary molding step described above each have a circular cylindrical shape. Such circular cylindrical outer sleeve 83 and inner sleeve 84 are each made as follows, in general: a thin plate member made of metal and having an oblong rectangular shape in plan view is bent into a circular cylindrical body such that one end portion and the other end portion of the thin plate member are brought into contact with each other, and the one end portion and the other end portion thus brought into contact with each other are joined to each other by welding.

The circular cylindrical outer sleeve 83 and inner sleeve 84 thus made are then combined with each other by fitting the inner sleeve 84 into the outer sleeve 83. The combination of the outer sleeve 83 and the inner sleeve 84 fitted to each other is then attached to the rotatable driving roller 85 while being moved in the axial direction of the rotatable driving roller 85 in such a manner as to cover the rotatable driving roller 85.

In this case, the inner sleeve 84 has an inside diameter that is smaller than the outside diameter of the rotatable driving roller 85. Furthermore, the outer sleeve 83 and the inner sleeve 84 are fitted to each other such that the outer peripheral surface of the inner sleeve 84 comes into contact with the entirety of or substantially the entirety of the inner peripheral surface of the outer sleeve 83. Furthermore, in attaching the outer sleeve 83 and the inner sleeve 84 to the rotatable driving roller 85, air is strongly blown radially outward from the outer peripheral surface of the rotatable driving roller 85, whereby the outer sleeve 83 and the inner sleeve 84 to be placed over the rotatable driving roller 85 are inflated such that the diameters of their circular cylindrical bodies increase. Thus, the outer sleeve 83 and the inner sleeve 84 are easily movable in the axial direction of the rotatable driving roller 85.

After the outer sleeve 83 and the inner sleeve 84 reach a predetermined position of the rotatable driving roller 85, the air blown from the rotatable driving roller 85 is stopped, whereby the outer sleeve 83 and the inner sleeve 84 contract such that the diameters thereof are reduced. Thus, the outer sleeve 83 and the inner sleeve 84 are attached and secured to the rotatable driving roller 85.

### CITATION LIST

### Patent Literature

### PTL 1: International Publication No. 2017/109902

### SUMMARY OF INVENTION

### Technical Problem

As described above, the outer sleeve 83 and the inner sleeve 84 of the die wheel 82 are each formed by welding one end portion and the other end portion of a thin plate member to each other. Therefore, the outer sleeve 83 and the inner sleeve 84 each have a welded part formed by welding the one end portion and the other end portion of the thin plate member to each other. The welded part extends linearly parallel to the axial direction of the circular cylindrical body from the edge of one of the bottoms of the circular cylindrical body to the edge of the other bottom.

On the other hand, in attaching the outer sleeve 83 and the inner sleeve 84 to the rotatable driving roller 85 of the die wheel 82, air blown from the rotatable driving roller 85 is used to first inflate the circular cylindrical bodies, and the air is then stopped to make the circular cylindrical bodies contract. That is, when the outer sleeve 83 and the inner sleeve 84 each having the welded part described above are attached to the rotatable driving roller 85, the welded part undergoes elastic deformation and plastic deformation.

More specifically, when the circular cylindrical bodies of the outer sleeve 83 and the inner sleeve 84 are inflated with the air blown from the rotatable driving roller 85 as described above, the welded parts of the outer sleeve 83 and the inner sleeve 84 undergo elastic deformation and plastic deformation in such a manner as to expand in the peripheral direction of their circular cylindrical bodies. Subsequently, when the air is stopped to make the outer sleeve 83 and the inner sleeve 84 contract, the expanded welded parts undergo elastic deformation and plastic deformation in such a manner as to slightly protrude radially outward.

Therefore, the outer peripheral surfaces of the outer sleeve 83 and the inner sleeve 84 thus attached to the rotatable driving roller 85 each have a protrusion slightly protruding outward and extending linearly parallel to the axial direction of the outer sleeve 83 and the inner sleeve 84. Furthermore, the outer peripheral surface of the outer sleeve 83 that is fitted on the outer side of the inner sleeve 84 has another protrusion attributed to the welded part of the inner sleeve 84, because the slight protrusion formed on the outer peripheral surface of the inner sleeve 84 is transferred to the outer peripheral surface of the outer sleeve 83. That is, the outer peripheral surface of the outer sleeve 83 attached to the rotatable driving roller 85 has two linear protrusions that are attributed to the welded part of the inner sleeve 84 and the welded part of the outer sleeve 83.

In such a case where the outer sleeve 83 has two protrusions at the outer peripheral surface thereof and the die wheel 82 including the outer sleeve 83 is used in manufacturing a surface fastener, the shapes of the protrusions of the outer sleeve 83 are transferred to the base part of the surface fastener, which is elongate in the machining direction, leaving a plurality of imprints (also referred to as transfer marks) including small concavities. In this case, the plurality of imprints each extend linearly in the width direction of the base part and appear regularly in the length direction of the base part.

Despite a recent-year demand for reduced thickness of the base part between the upper surface and the lower surface thereof for the purpose of a reduction in the manufacturing cost of the surface fastener and an increase in the flexibility of the surface fastener, there is a limit in the thickness reduction of the base part in the primary molding step that is performed by using the above die wheel 82. Therefore, to reduce the thickness of the base part, a process is under examination and is promoted to be practically implemented in which, for example, a surface fastener obtained from the secondary molding step is delivered to a stretching device, where the base part of the surface fastener is subjected to a stretching process to be stretched in the machining direction (transporting direction).

If, however, a surface fastener having a plurality of imprints formed in the base part thereof and each extending in the width direction thereof as described above is subjected to a stretching process to be stretched in the machining direction, the stretching process stretches the base part more actively in regions having the imprints than in regions having no imprints. Therefore, the thickness of the surface fastener obtained from the stretching process is greatly reduced in the regions having the imprints.

Accordingly, factors such as the dimension of the base part in the thickness direction (hereinafter referred to as the thickness dimension) and the pitch of the engaging elements formed tend to vary in the length direction of the surface fastener (the machining direction), and such variations may lead to variations in the peel strength of the surface fastener (particularly, variations in the length direction). In addition, since the imprints, including concavities, formed in the base part are stretched preferentially in the stretching process, the base part may deform such that the concavities stand out, affecting the appearance quality of the surface fastener.

The present invention has been conceived in view of the above problems, and an object of the present invention is to provide a surface-fastener-manufacturing method that enables the manufacture of a surface fastener in which transfer marks resulting from the transfer of a welded part of a sleeve is less noticeable even after a stretching process is performed on a molded body obtained from a molding step, and in which peel strength is less likely to vary, and also provide a surface fastener manufactured through the manufacturing method, and a molding device to be used in the manufacturing method.

### Solution to Problem

To achieve the above object, the present invention provides a surface-fastener-manufacturing method of manufacturing a surface fastener made of synthetic resin and including a base part having a plurality of engaging elements, the method including at least a molding step of performing molding by feeding molten synthetic resin toward a die wheel that is rotating in one direction; and a stretching step of performing a stretching process in a machining direction after the molding step. The manufacturing method is characterized by comprising using the die wheel in the molding step, the die wheel including at least one sleeve having cavities with which the engaging elements or tentative elements to be deformed into the engaging elements are to be molded, the sleeve having a circular cylindrical shape and obtained from a metal thin plate member by bringing one end portion and an other end portion of the thin plate member in a first direction into contact with each other and joining the one end portion and the other end portion brought into contact with each other to each other by welding, the one end portion and the other end portion joined to each other forming a welded part, the welded part being inclined at an angle of 4° or greater with respect to a second direction, the second direction being orthogonal to the first direction and disposed along an axial direction of the sleeve.

In the surface-fastener-manufacturing method according to the present invention, it is preferable that the sleeve include an outer sleeve and an inner sleeve that is closely in contact with an inner peripheral surface of the outer sleeve, the outer sleeve have a plurality of through-holes penetrating through the outer sleeve from an outer peripheral surface to the inner peripheral surface of the outer sleeve, the inner sleeve have a plurality of recessed portions provided in an outer peripheral surface of the inner sleeve, and an outer peripheral edge of at least one of the through-holes at the inner peripheral surface of the outer sleeve include a portion that overlaps a recessed portion provided in the inner sleeve.

Furthermore, it is preferable that the inner sleeve be made of a softer metal than the outer sleeve.

The present invention further provides a surface fastener made of synthetic resin and including a base part and a plurality of engaging elements, the base part having a first surface and a second surface that face away from each other, the engaging elements projecting from the first surface of the base part, the base part being shaped as a thin plate that is elongated in a first direction. The surface fastener is characterized in that the base part has a thickness dimension between the first surface and the second surface of smaller than 90 μm, the first surface of the base part has a transferred unevenness portion including a concave portion and a convex portion that are formed in the first surface, the transferred unevenness portion is formed linearly along a direction inclined at an angle of 4° or greater with respect to a second direction that is orthogonal to the first direction, and an unevenness height difference in the transferred unevenness portion is 20 μm or smaller.

The present invention further provides a molding device to be used in manufacturing a surface fastener, the surface fastener being made of synthetic resin and including a base part having a plurality of engaging elements, the molding device including a die wheel configured to rotate in one direction; and a feeding nozzle configured to feed molten synthetic resin toward the die wheel. The molding device is characterized in that the die wheel includes at least one sleeve having cavities with which the engaging elements or tentative elements to be deformed into the engaging elements are to be molded, the sleeve has a circular cylindrical shape and is obtained from a metal thin plate member by bringing one end portion and an other end portion of the thin plate member in a first direction into contact with each other and joining the one end portion and the other end portion brought into contact with each other to each other by welding, and the one end portion and the other end portion joined to each other form a welded part, the welded part being inclined at an angle of 4° or greater with respect to a second direction, the second direction being orthogonal to the first direction and disposed along an axial direction of the sleeve.

In the molding device according to the present invention, it is preferable that the sleeve include an outer sleeve and an inner sleeve that is closely in contact with an inner peripheral surface of the outer sleeve, the outer sleeve have a plurality of through-holes penetrating through the outer sleeve from an outer peripheral surface to the inner peripheral surface of the outer sleeve, the inner sleeve have a plurality of recessed portions provided in an outer peripheral surface of the inner sleeve, and an outer peripheral edge of at least one of the through-holes at the inner peripheral surface of the outer sleeve include a portion that overlaps a recessed portion provided in the inner sleeve.

Furthermore, it is preferable that the inner sleeve be made of a softer metal than the outer sleeve.

### Advantageous Effects of Invention

The manufacturing method according to the present invention provides a surface fastener in which transfer marks (transferred unevenness portions) resulting from the transfer of a welded part of a sleeve is less noticeable than in the known art even after a stretching process is performed on a molded body obtained from a molding step, and in which peel strength is less likely to vary than in the known art.

### BRIEF DESCRIPTION OF DRAWINGS

FIG. 1 is a schematic diagram schematically illustrating a manufacturing apparatus to be used in a surface-fastener-manufacturing method according to an example of the present invention.

FIG. 2 is a schematic perspective view of an outer sleeve and an inner sleeve provided in a primary molding device included in the manufacturing apparatus illustrated in FIG. 1.

FIG. 3 is a schematic plan view of a metal thin plate member to be formed into the outer sleeve.

FIG. 4 is a schematic sectional view of a die wheel included in the molding device.

FIG. 5 is a schematic perspective view of a primary molded body to be molded in a primary molding step.

FIG. 6 is a schematic sectional view of a relevant part of a pre-fastener body to be molded in a secondary molding step.

FIG. 7 is a schematic perspective view of a surface fastener to be manufactured through the manufacturing method according to the example.

FIG. 8 is a schematic diagram schematically illustrating a known surface-fastener-manufacturing apparatus.

### DESCRIPTION OF EMBODIMENTS

A preferred embodiment of the present invention will now be described in detail with reference to the drawings. The present invention is not limited to the following embodiment in any way and may be modified in various ways as long as such modifications provide substantially the same configuration and produce the same advantageous effects as the present invention.

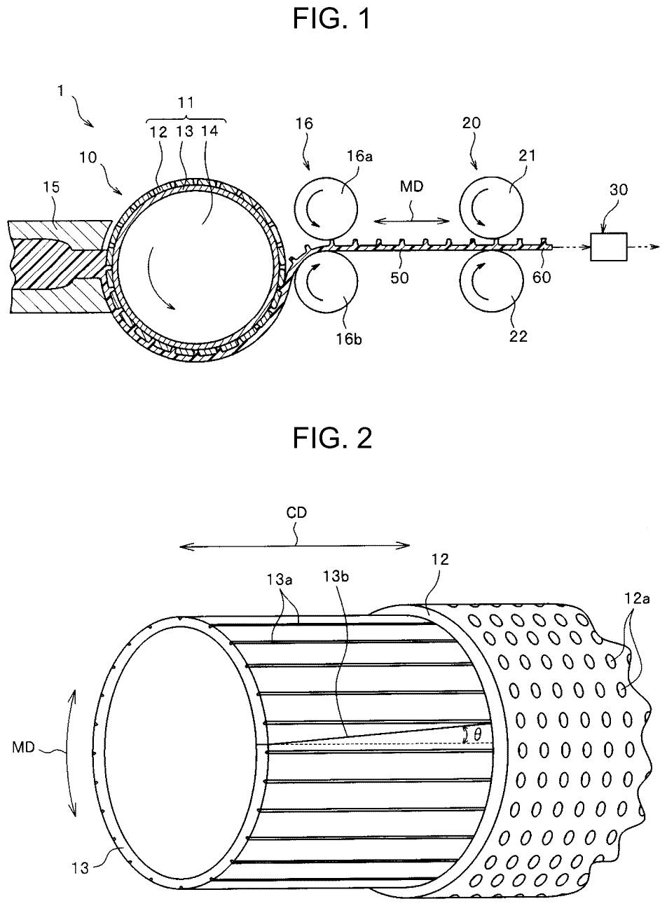

FIG. 1 is a schematic diagram schematically illustrating a manufacturing apparatus to be used in a surface-fastener-manufacturing method according to the present embodiment. FIG. 2 is a schematic perspective view of an outer sleeve and an inner sleeve provided in a primary molding device included in the manufacturing apparatus.

In the following description, a machining direction (an M direction or MD) is a direction in which a primary molded body, a pre-fastener body, and a surface fastener are to be transported in a process of manufacturing a surface fastener and is also referred to as the front-rear direction. The machining direction and the front-rear direction are each the length direction of the primary molded body, the pre-fastener body, and the surface fastener, which are each molded in an elongated shape.

A cross direction (a C direction or CD) is a width direction that is orthogonal to the machining direction and disposed along the upper surface (first surface), which is substantially flat, of a base part or tentative base part and is also referred to as the left-right direction. The cross direction and the left-right direction are each the width direction of the primary molded body, the pre-fastener body, and the surface fastener each molded in an elongated shape.

A thickness direction is a direction disposed along a direction orthogonal to the substantially flat upper surface of the base part and is also referred to as the up-down direction or the height direction. The thickness direction and the up-down direction are each a direction orthogonal to both the machining direction and the cross direction. Herein, with reference to the base part, a side toward which engaging elements project is defined as the upper side, and a side opposite the upper side is defined as the lower side.

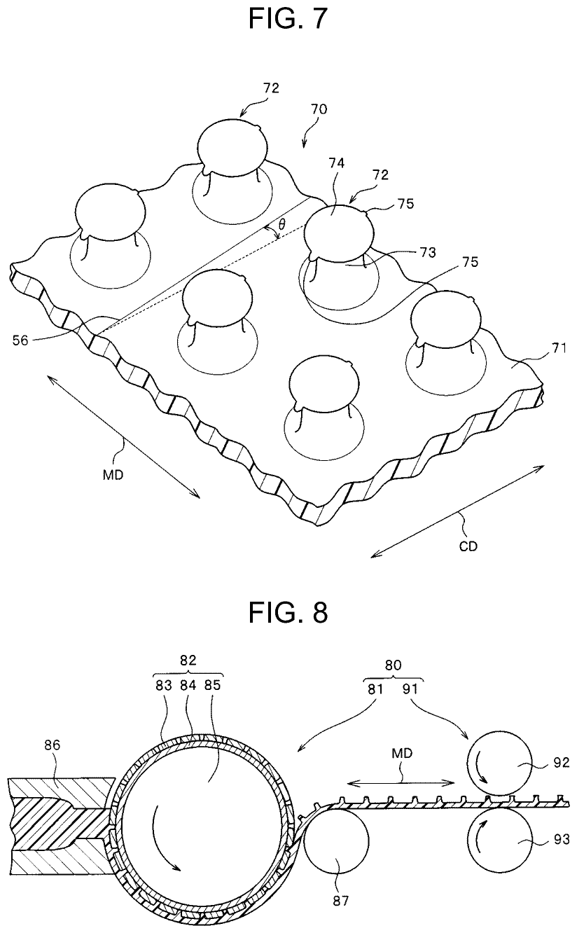

The manufacturing method according to the present embodiment provides a surface fastener 70, which is made of synthetic resin and in which, as illustrated in FIG. 7, a plurality of engaging elements 72 are formed integrally with a thin plate-like base part 71 at the upper surface of the base part 71. The surface fastener 70 is elongated in the machining direction MD of a manufacturing apparatus 1, which is illustrated in FIG. 1.

The manufacturing apparatus 1 configured to manufacture the surface fastener 70 will now be described with reference to FIGS. 1 and 2.

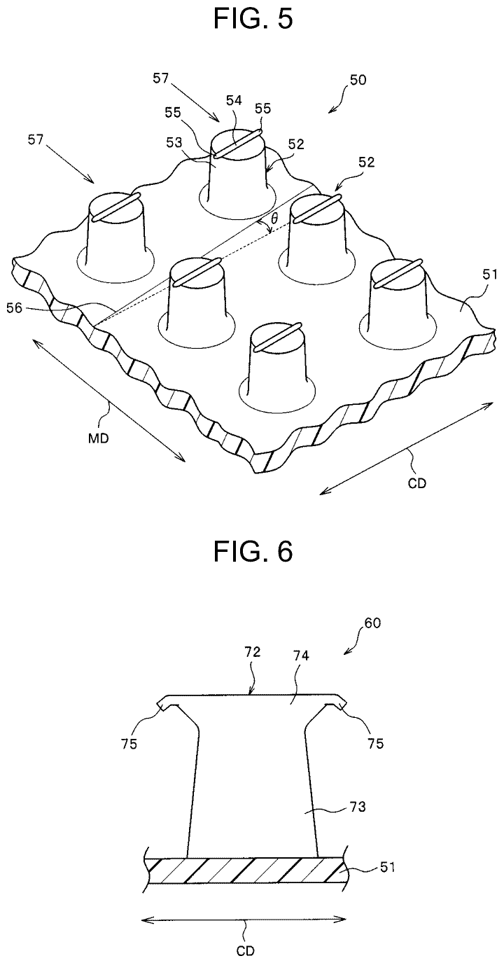

The manufacturing apparatus 1 according to the present embodiment includes a primary molding device 10, which is configured to perform primary molding; a hot pressing device (secondary molding device) 20, which is configured to mold a pre-fastener body (secondary molded body) 60, illustrated in FIG. 6, by performing secondary molding on a primary molded body 50, illustrated in FIG. 5, molded by the primary molding device 10; and a stretching device 30, which is configured to perform a stretching process on the pre-fastener body 60 thus obtained. In the present invention, the pre-fastener body 60 refers to a molded body or member that is obtained in a case where the manufacture of the surface fastener 70 includes a stretching process, and that is yet to undergo the stretching process.

The primary molding device 10 includes a die wheel 11, which is driven to rotate in one direction (the counterclockwise direction in the drawing); a feeding nozzle 15, which is provided facing the peripheral surface of the die wheel 11 and is configured to continuously extrude or discharge a molten synthetic resin material; and a pickup roller 16, which is provided on the downstream side relative to the feeding nozzle 15 in the direction of rotation of the die wheel 11.

The die wheel 11 includes a circular cylindrical outer sleeve 12 (also referred to as an outer cylinder), which serves as a die; a circular cylindrical inner sleeve 13 (also referred to as an inner cylinder), which is provided on the inner side of and in close contact with the outer sleeve 12; and a rotatable driving roller 14, to which the outer sleeve 12 and the inner sleeve 13 are attached. The rotatable driving roller 14 is configured to cause the outer sleeve 12 and the inner sleeve 13 attached to the rotatable driving roller 14 to rotate in the one direction (the counterclockwise direction in FIG. 1). The rotatable driving roller 14 is provided thereinside with a cooling jacket, which is not illustrated but allows cooling liquid to flow through.

The outer sleeve 12 has, as illustrated in FIG. 2 for example, a plurality of through-holes 12a, which extend through the outer sleeve 12 from the outer peripheral surface to the inner peripheral surface and each serve as a cavity for molding a part of the below-described primary element, 52, of the primary molded body 50. In the present embodiment, for example, synthetic resin is fed into the through-holes 12a of the outer sleeve 12, whereby the below-described primary stem portions, 53, of the primary elements 52 are molded.

In the present embodiment, the plurality of through-holes 12a are arranged in correspondence with the positions where the engaging elements 72 of the pre-fastener body 60 illustrated in FIG. 6 are to be formed. In the present embodiment, for example, the plurality of through-holes 12a are regularly arranged at constant intervals in the machining direction MD (the peripheral direction of the outer sleeve 12) and are regularly arranged at constant intervals in the cross direction CD (a direction parallel to the rotation axis of the outer sleeve 12).

The through-holes 12a each have a substantially circular truncated conical shape with a circle at the outer peripheral surface of the outer sleeve 12 being greater than a circle at the inner peripheral surface of the outer sleeve 12. In the present invention, the positions, sizes, shapes, and other relevant factors of the plurality of through-holes 12a provided in the outer sleeve 12 are not particularly limited.

The outer peripheral surface of the inner sleeve 13 has a plurality of recessed groove portions 13a, which each serve as a cavity for molding portions of the primary element 52 (specifically, a rib portion 54 and projecting portions 55 to be described below). The recessed groove portions 13a each linearly extend in the cross direction CD parallel to the rotation axis of the inner sleeve 13 and are each recessed in a size that allows molten synthetic resin to flow in.

The plurality of recessed groove portions 13a are arranged at regular intervals in the peripheral direction of the inner sleeve 13 (the machining direction MD). With the die wheel 11 assembled, at least a portion of each of the recessed groove portions 13a of the inner sleeve 13 intersects the outer peripheral edges of corresponding ones of the through-holes 12a at the inner peripheral surface of the outer sleeve 12. According to the present invention, the form of the recessed portions provided in the outer peripheral surface of the inner sleeve is not limited to the linear recessed groove portions 13a according to the present embodiment. The recessed portion according to the present invention encompasses, for example, a recessed groove portion that is bent in a zigzag shape; and a recessed depression portion that is depressed three-dimensionally, in a cuboidal shape or the like, relative to the outer peripheral surface of the inner sleeve.

The outer sleeve 12 and the inner sleeve 13 according to the present embodiment are each made through a sleeve-making process including a welding process. Therefore, the outer sleeve 12 and the inner sleeve 13 thus made have respective welded parts 12b and 13b. The welded parts 12b and 13b are formed in the welding process and each extend linearly and continuously from one end edge (left side edge) to the other end edge (right side edge) of the outer sleeve 12 or the inner sleeve 13 in the cross direction CD.

The welded part 12b formed in the outer sleeve 12 and the welded part 13b formed in the inner sleeve 13 are located at a position rotated by 180° from each other when seen in a cross section (FIG. 4) of the die wheel 11 that is taken orthogonally to the rotation axis, as to be described below. Therefore, in FIG. 2, while the welded part 13b of the inner sleeve 13 is illustrated, the welded part 12b of the outer sleeve 12 is at a position hidden in FIG. 2. In FIG. 4, the welded part 12b of the outer sleeve 12 and the welded part 13b of the inner sleeve 13 are intentionally illustrated by solid lines for easy identification of the locations of the welded parts 12b and 13b.

Now, the sleeve-making process will be described specifically, in which the outer sleeve 12 is made from a thin plate member 18.

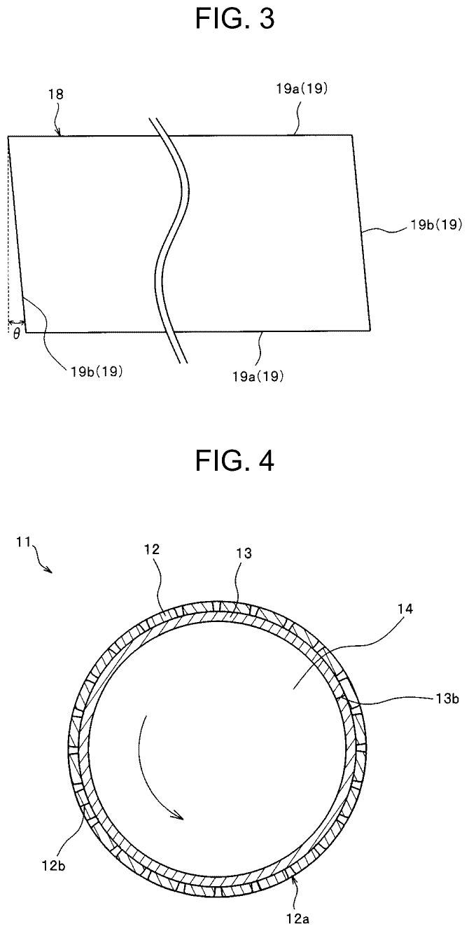

To make the outer sleeve 12, a thin plate member 18 shaped as illustrated in FIG. 3 is first prepared. The thin plate member 18 is made of stainless steel. Stainless steel is an alloy steel chiefly composed of iron, with carbon and chromium at respective percentage concentrations by mass of 1.2% or below and 10.5% or above (ISO standards).

In the present embodiment, for example, the plurality of through-holes 12a of the outer sleeve 12 are provided through a hole-making process to be described below. Therefore, a hard stainless steel is preferable as the thin plate member 18 for the outer sleeve 12, because such a stainless steel tends to exhibit satisfactory strength even after the plurality of through-holes 12a are provided therein. In the present invention, the outer sleeve 12 may be made of any metal other than stainless steel but may preferably be made of a metal harder than that for the inner sleeve 13, so as to have appropriate strength.

The thin plate member 18 for the outer sleeve 12 has a parallelogram shape when seen from above, that is, in plan view (FIG. 3). Alternatively, the thin plate member 18 may have a substantially parallelogram shape that is close to a parallelogram. The thin plate member 18 having a parallelogram shape has two pairs of sides 19 (namely, first-pair sides 19a and second-pair sides 19b), each pair of sides 19 being parallel to and opposite each other. One of the two pairs, specifically the first-pair sides 19a (the upper and lower sides 19 in FIG. 3), extend parallel to a first direction. The other of the two pairs, specifically the second-pair sides 19b (the left and right sides 19 in FIG. 3), extend in a direction inclined with respect to a second direction. The second direction is orthogonal to the first direction. In such a case, the first direction corresponds to the peripheral direction of the outer sleeve 12 or the machining direction MD, and the second direction corresponds to the rotation-axis direction of the outer sleeve 12 or the cross direction CD.

In the present embodiment, the inclination angle, θ, at which the second-pair sides 19b of the thin plate member 18 are inclined with respect to the second direction (cross direction CD) is set to 4° or greater. Such a setting of the inclination angle θ makes it difficult for the outer sleeve 12 to undergo elastic deformation and plastic deformation at the welded part 12b when the outer sleeve 12 is attached to the rotatable driving roller 14 as to be described below. Consequently, the below-described transferred unevenness portions (transfer marks) 56, that are to be formed in the surface fastener 70 because of the shape of the welded part 12b can be made it difficult to be noticeable, and the unevenness height difference in the transferred unevenness portions 56 can be reduced. To make the outer sleeve 12 less likely to undergo elastic deformation and plastic deformation at the welded part 12b when the outer sleeve 12 is attached to the rotatable driving roller 14, the inclination angle θ of the second-pair sides 19b may preferably be set to 45° or smaller.

In the present embodiment, after the thin plate member 18 illustrated in FIG. 3 is prepared, the thin plate member 18 is bent in such a manner as to be rolled in the first direction, and the second-pair sides 19b of the bent thin plate member 18 (that is, one side edge and the other side edge of the thin plate member 18 in the first direction) are brought into contact with each other. Subsequently, a welding process is performed on the second-pair sides 19b of the thin plate member 18 thus brought into contact with each other, whereby the second-pair sides 19b are joined to each other. Thus, a circular cylinder having a space extending in the second direction thereinside is obtained. The circular cylinder has a welded part 12b, which is formed at the second-pair sides 19b joined to each other. Note that the inclination angle θ of the second-pair sides 19b may preferably be set to 20° or smaller, particularly 15° or smaller. Thus, the length of the second-pair sides 19b is made less likely to be greater than the dimension (the width dimension) of the thin plate member 18 in the second direction, and the ease of the welding process to be performed in forming the circular cylinder is increased.

After the completion of the above welding process, the circular cylinder is subjected to a hole-making process, whereby a plurality of through-holes 12a are made. Thus, an outer sleeve 12 according to the present embodiment is obtained. In the present embodiment, the outer sleeve 12 may alternatively be made by first performing the hole-making process on the thin plate member 18 illustrated in FIG. 3 to make a plurality of through-holes 12a, and then performing the above welding process on the thin plate member 18 having the through-holes 12a.

To make the inner sleeve 13, as with the case of the outer sleeve 12, a thin plate member made of stainless steel and having a parallelogram shape or a substantially parallelogram shape as illustrated in FIG. 3 is prepared. In the present embodiment, the thin plate member for the inner sleeve 13 is to be subjected to a groove-making process for making the recessed groove portions 13a. Therefore, a stainless steel that is softer and has higher workability than that for the outer sleeve 12 is preferably used for the inner sleeve 13. In the present invention, the inner sleeve 13 may alternatively be made of a metal other than stainless steel. Furthermore, the inner sleeve 13 is, but is not limited to be, made of a softer metal than the outer sleeve 12.

The thin plate member for the inner sleeve 13 has, as with the case of the outer sleeve 12, first-pair sides that extend parallel to the first direction (machining direction MD) and second-pair sides that extend parallel to a direction inclined with respect to the second direction (cross direction CD). The inclination angle θ of the second-pair sides with respect to the second direction is set to 4° or greater. The inclination angle θ of the second-pair sides may preferably be set to 45° or smaller. Considering the ease of the welding process, the inclination angle θ may preferably be set to 20° or smaller, particularly 15° or smaller.

In the present embodiment, a groove-making process is performed on one surface (a first surface) of the thin plate member for the inner sleeve 13, whereby a plurality of recessed groove portions 13a are provided parallel to the second direction. Subsequently, the thin plate member now having the recessed groove portions 13a is bent in such a manner as to be rolled in the first direction, and the second-pair sides of the bent thin plate member are brought into contact with each other. Subsequently, a welding process is performed on the second-pair sides of the thin plate member thus brought into contact with each other, whereby the second-pair sides are joined to each other. Thus, an inner sleeve 13 according to the present embodiment is obtained that has a circular cylindrical shape and includes a welded part 13b formed by joining the second-pair sides to each other.

In the present embodiment, the inner sleeve 13 may alternatively be made by performing a welding process on a thin plate member to obtain a circular cylinder, and then performing a groove-making process on the circular cylinder to make a plurality of recessed groove portions 13a. In the present embodiment, the welded parts 12b and 13b of the outer sleeve 12 and the inner sleeve 13 are both formed at an inclination angle θ of 4° or greater with respect to the cross direction CD. In the present invention, however, at least one of the welded part of the outer sleeve and the welded part of the inner sleeve only needs to be formed at an inclination angle θ of 4° or greater with respect to the cross direction CD, and the other welded part may be formed parallel to the cross direction CD or at an inclination angle θ of smaller than 4° with respect to the cross direction CD.

After the outer sleeve 12 and the inner sleeve 13 are made from the respective thin plate members 18 as described above, the outer sleeve 12 and the inner sleeve 13 are attached to the rotatable driving roller 14 in such a manner as to cover the rotatable driving roller 14. In the present embodiment, a preferable method to be employed in the process of attaching the outer sleeve 12 and the inner sleeve 13 to the rotatable driving roller 14 is inflating the outer sleeve 12 and the inner sleeve 13 by strongly blowing air radially outward from the rotatable driving roller 14. In such a case, the rotatable driving roller 14 is configured to be capable of blowing air from the outer peripheral surface of the rotatable driving roller 14. Furthermore, the rotatable driving roller 14 is made such that the outside diameter of the rotatable driving roller 14 is slightly greater than the inside diameter of the inner sleeve 13.

Here, a method of attaching the outer sleeve 12 and the inner sleeve 13 to the rotatable driving roller 14 will be described.

First, the inner sleeve 13 is inserted into the outer sleeve 12, and the outer sleeve 12 and the inner sleeve 13 are fitted to each other such that the outer peripheral surface of the inner sleeve 13 is in contact with the entirety of or substantially the entirety of the inner peripheral surface of the outer sleeve 12.

At the time, the outer sleeve 12 and the inner sleeve 13 are fitted to each other in a positional relationship of the outer sleeve 12 and the inner sleeve 13 in which at least a portion of the recessed groove portions 13a of the inner sleeve 13 overlaps the outer peripheral edge of at least one of the through-holes 12a formed at the inner peripheral surface of the outer sleeve 12. Furthermore, the outer sleeve 12 and the inner sleeve 13 are fitted to each other so that the welded part 12b of the outer sleeve 12 and the welded part 13b of the inner sleeve 13 are disposed at a position rotated by 180° from each other when seen in a cross section (FIG. 4) taken orthogonally to the rotation-axis direction of the outer sleeve 12 and the inner sleeve 13. Alternatively, in the process of fitting the outer sleeve 12 and the inner sleeve 13 to each other, the welded parts 12b and 13b may be set at any positions other than at a position rotated by 180° from each other as long as the welded parts 12b and 13b do not coincide with each other.

Subsequently, the outer sleeve 12 and the inner sleeve 13 thus fitted to each other are attached to the rotatable driving roller 14. In this process, air is strongly blown radially outward from the outer peripheral surface of the rotatable driving roller 14. Meanwhile, the outer sleeve 12 and the inner sleeve 13 fitted to each other are brought close to the rotatable driving roller 14 from which air is being blown and are moved in the rotation-axis direction of the rotatable driving roller 14 in such a manner as to cover the rotatable driving roller 14 (in other words, such that the rotatable driving roller 14 is inserted into the inner sleeve 13).

Accordingly, the outer sleeve 12 and the inner sleeve 13 fitted to each other receive from the inner peripheral side of the inner sleeve 13 the pressure of the air blown from the rotatable driving roller 14 and are inflated to have increased diameters. Thus, the inside diameter of the inner sleeve 13 is made greater than the outside diameter of the rotatable driving roller 14. Therefore, the outer sleeve 12 and the inner sleeve 13 are easily movable along the rotatable driving roller 14 to a predetermined attaching position.

In such a case, with the expansion of the outer sleeve 12 and the inner sleeve 13, the welded parts 12b and 13b of the outer sleeve 12 and the inner sleeve 13 each undergo elastic deformation and plastic deformation in such a manner as to expand in the peripheral direction of the outer sleeve 12 or the inner sleeve 13. Nevertheless, the welded parts 12b and 13b according to the present embodiment each extend in a direction inclined at an inclination angle θ of 4° or greater with respect to the rotation-axis direction of the outer sleeve 12 and the inner sleeve 13. Therefore, comparing the welded parts 12b and 13b of the outer sleeve 12 and the inner sleeve 13 with, for example, the welded parts of the outer sleeve and the inner sleeve in the known art that each extend in the rotation-axis direction, the stress (tensile force) applied to the welded parts 12b and 13b at the expansion of the outer sleeve 12 and the inner sleeve 13 is dispersed, whereby the magnitude of the elastic deformation and plastic deformation (the amount of deformation) of the welded parts 12b and 13b is reduced.

After the outer sleeve 12 and the inner sleeve 13 are moved relative to the rotatable driving roller 14 to the predetermined attaching position, the air blown from the rotatable driving roller 14 is stopped. Accordingly, the outer sleeve 12 and the inner sleeve 13 that have been inflated with the pressure of the air contract in such a direction as to have reduced diameters and fasten the rotatable driving roller 14. Consequently, the outer sleeve 12 and the inner sleeve 13 are closely in contact with each other at the inner peripheral surface of the outer sleeve 12 and the outer peripheral surface of the inner sleeve 13, and the inner peripheral surface of the inner sleeve 13 is closely in contact with the rotatable driving roller 14. Thus, the outer sleeve 12 and the inner sleeve 13 are attached to the rotatable driving roller 14 with no gap and are secured to the rotatable driving roller 14 with no displacement in the direction of rotation.

In this process, since the welded parts 12b and 13b of the outer sleeve 12 and the inner sleeve 13 undergo elastic deformation and plastic deformation in such a manner as to expand in the peripheral direction at the expansion of the outer sleeve 12 and the inner sleeve 13, when the outer sleeve 12 and the inner sleeve 13 contract, the welded parts 12b and 13b undergo elastic deformation and plastic deformation in such a manner as to protrude radially outward. In the present embodiment, however, since the amount of deformation in the elastic deformation and plastic deformation undergone by the outer sleeve 12 and the inner sleeve 13 at the expansion thereof is small, the sizes of the protrusions (the heights of the protrusions) formed on the outer peripheral surfaces of the outer sleeve 12 and the inner sleeve 13 are smaller than in the case of, for example, the outer sleeve and the inner sleeve in the known art.

Thus, in the die wheel 11 according to the present embodiment in which the outer sleeve 12 and the inner sleeve 13 are secured to the rotatable driving roller 14, the two protrusions formed on the outer peripheral surface of the outer sleeve 12 because of the elastic deformation and plastic deformation at the welded parts 12b and 13b of the outer sleeve 12 and the inner sleeve 13 are smaller than in the known art. Furthermore, in the present embodiment, the two small protrusions formed on the outer peripheral surface of the outer sleeve 12 are located in symmetry position rotated by 180° from each other as described above.

The pickup roller 16 illustrated in FIG. 1 includes a pair of an upper nipping roller 16a and a lower nipping roller 16b, which are configured to nip the primary molded body 50 molded on the outer peripheral surface of the die wheel 11 from above and below and pull the primary molded body 50. The upper nipping roller 16a and the lower nipping roller 16b each have at the outer peripheral surface thereof a surface layer, which is not illustrated but is made of elastomer such as polyurethane elastomer.

The hot pressing device 20 includes a pair of upper and lower pressing rollers (calender rollers) 21 and 22, which are provided on the downstream side relative to the pickup roller 16. The upper pressing roller 21 and the lower pressing roller 22 are positioned facing each other with a predetermined gap therebetween. The gap between the upper pressing roller 21 and the lower pressing roller 22 is adjustable by height-adjusting means, which is not illustrated.

The upper pressing roller 21 includes thereinside a heat source, which is not illustrated. The surface temperature of the upper pressing roller 21 is set to a temperature that softens the synthetic resin to be formed into the surface fastener 70. In the present invention, the configuration of the hot pressing device 20 is not particularly limited as long as the hot pressing device 20 is capable of forming the engaging elements 72 by pressing at least a portion of the primary molded body 50 as to be described below.

As illustrated in FIG. 1, the stretching device 30 is installed on the downstream side relative to the hot pressing device 20 so as to perform at least a stretching process on the pre-fastener body (secondary molded body) 60 molded by the hot pressing device 20. Although specific illustration is omitted, the stretching device 30 includes a feeding unit configured to introduce the pre-fastener body 60 into the stretching device 30, a discharging unit configured to deliver the surface fastener 70 obtained through the stretching process toward the downstream side, and a plurality of rotatable rollers arranged between the feeding unit and the discharging unit and along a transport path for a processing object (that is, the pre-fastener body 60 or the surface fastener 70).

The rotatable rollers are each configured to rotate while the processing object is kept in contact therewith, thereby being capable of transporting the processing object at a speed corresponding to the rotation speed thereof and toward the downstream side. At least one of the rotatable rollers is capable of heating the processing object with a preset heating temperature while the processing object is kept in contact with the outer peripheral surface of the roller.

The rotatable rollers of the stretching device 30 include a heating roller configured to perform a heating treatment on the pre-fastener body 60, a stretching roller configured to perform a stretching process on the pre-fastener body 60 in cooperation with the heating roller, and a relaxing roller provided on the downstream side relative to the stretching roller. In such a case, the heating roller, the stretching roller, and the relaxing roller are arranged such that the transport path for the processing object meanders up and down.

The heating roller is configured to transport the pre-fastener body 60 by rotating at a constant speed and to heat the pre-fastener body 60 with the pre-fastener body 60 being kept in contact with the roller surface thereof. The heating roller is provided with a supporting roller (nip roller) provided facing the heating roller. The heating roller and the supporting roller are configured to rotate at respective constant speeds while nipping and holding the pre-fastener body 60 therebetween from above and below. With the heating roller, the pre-fastener body 60 that is yet to undergo the stretching process is heated to such a temperature as to be stretchable. In the present embodiment, the means and method for performing the heating treatment before the stretching process are not particularly limited.

The stretching roller is controlled to rotate at a higher rotation speed than the heating roller with the processing object being kept in contact with the roller surface thereof. For example, in the present embodiment, the rotation speed of the stretching roller is set to 110% or higher and 200% or lower of the rotation speed of the heating roller. The heating temperature of the stretching roller is set higher than or equal to the heating temperature of the heating roller and lower than the melting point of the synthetic resin to be formed into the surface fastener 70. The above combination of the heating roller and the stretching roller enables the performance of the stretching process on the pre-fastener body 60. Through the stretching process, the below-described tentative base part, 51, of the pre-fastener body 60 is stretched in the machining direction MD, whereby the base part 71 of the surface fastener 70 is obtained.

The relaxing roller is controlled to rotate at a lower rotation speed than the stretching roller with the processing object being kept in contact with the roller surface thereof. The heating temperature of the relaxing roller is set lower than the melting point of the synthetic resin to be formed into the surface fastener 70. Thus, the tension to be applied to the surface fastener 70 between the stretching roller and the relaxing roller is reduced, whereby the shape and dimensions of the surface fastener 70 are stabilized.

The configuration of the stretching device 30 according to the above embodiment is only exemplary. In the present invention, the configuration of the stretching device is not particularly limited as long as the stretching device is located on the downstream side relative to at least the molding device and is capable of stretching in the machining direction MD a molded body, such as the pre-fastener body 60, delivered from the primary molding device 10 or the hot pressing device 20.

Now, a manufacturing method in which a surface fastener 70 is to be manufactured by using the above-described manufacturing apparatus 1 including the primary molding device 10, the hot pressing device 20, and the stretching device 30 will be described.

The method of manufacturing a surface fastener 70 according to the present embodiment includes a primary molding step of molding a primary molded body 50, such as the one illustrated in FIG. 5, by using the primary molding device 10; a secondary molding step of molding a pre-fastener body 60 including a plurality of engaging elements 72, such as the one illustrated in FIG. 6, in such a manner as to deform portions of the primary molded body 50 by using the hot pressing device 20; and a stretching step of obtaining a surface fastener 70 through a stretching process performed on the pre-fastener body 60 in the machining direction MD by using the stretching device 30. The method of manufacturing a surface fastener 70 according to the present invention may further include one or more steps in each of which any process or treatment other than the primary molding step, the secondary molding step, and the stretching step described above is performed.

In the primary molding step, molten synthetic resin is continuously fed from the feeding nozzle 15 toward the outer peripheral surface of the die wheel 11. In the present embodiment, the synthetic resin to be formed into a surface fastener 70 is polypropylene and is fed in a molten state from the feeding nozzle 15. Thus, a tentative base part 51 is continuously molded between the feeding nozzle 15 and the die wheel 11. Furthermore, a plurality of primary elements 52 (tentative elements) are molded integrally with the tentative base part 51 by the outer sleeve 12 and the inner sleeve 13 of the die wheel 11.

In the present invention, the kind of the synthetic resin to be formed into the surface fastener 70 is not limited. The material for the surface fastener 70 may be, for example, thermoplastic resin such as polypropylene, polyester, nylon, polybutylene terephthalate, or a copolymer of any of the foregoing. The primary molding device 10 may alternatively be configured to, for example, feed a molten synthetic resin material from a feeding nozzle toward a gap between two die wheels positioned facing each other. In such a configuration, the tentative base part is to be molded between the pair of die wheels, and the plurality of primary elements are to be molded by the outer sleeve and the inner sleeve of one of the die wheels.

Through the primary molding step according to the present embodiment, a primary molded body 50 such as the one illustrated in FIG. 5 is molded. The primary molded body 50 includes the tentative base part 51, which is a thin plate having an upper surface (first surface) and a lower surface (second surface); and the plurality of primary elements 52, which project from the upper surface of the tentative base part 51.

The upper surface and the lower surface of the tentative base part 51 are flat or substantially flat. The upper surface of the tentative base part 51 receives the shapes of the above-described protrusions formed on the outer peripheral surface of the outer sleeve 12 of the die wheel 11, thereby having transferred unevenness portions 56, such as the one illustrated in FIG. 5. Specifically, the primary molded body 50 has a plurality of transferred unevenness portions 56 that are formed at positions corresponding to the protrusions of the outer sleeve 12 and at intervals from one another in the length direction.

The transferred unevenness portions 56 of the primary molded body 50 are difficult to identify in direct visual observation but are of such a size as to be identifiable when, for example, the upper surface of the tentative base part 51 is measured through a laser microscope. As with the protrusions of the outer sleeve 12, the transferred unevenness portions 56 of the primary molded body 50 each is formed linearly along a direction inclined at an inclination angle θ of 4° or greater with respect to the cross direction CD and continuously or discontinuously. Furthermore, the transferred unevenness portions 56 each may include one concave portion and two convex portions formed on the front and rear sides, respectively, of the concave portion. The one concave portion and the two convex portions are observable in a measurement of the upper surface of the tentative base part 51 in the machining direction MD through a laser microscope. Such a convex portion may protrude relative to the concave portion or the upper surface of the tentative base part 51 or may not necessarily need to apparently protrude relative to the upper surface of the tentative base part 51. The convex portion may be formed only on one of the front and rear sides of the concave portion.

The primary elements 52 included in the primary molded body 50 are portions that are to undergo secondary molding (press molding) in the secondary molding step, thereby being deformed into respective engaging elements 72. In the present embodiment, the plurality of primary elements 52 are regularly arranged on the upper surface of the tentative base part 51 in a grid pattern in which the primary elements 52 are arrayed in the machining direction MD and in the cross direction CD. Therefore, the plurality of engaging elements 72 molded from the primary elements 52 are also regularly arranged in a grid pattern. In such a configuration, the primary elements 52 are at regular pitches (intervals) in the machining direction MD, thereby forming element rows 57. Furthermore, a plurality of such element rows 57 are side by side at regular intervals in the cross direction CD.

In the present invention, factors such as the number, size (width and height), arrangement pattern, and arrangement density of the primary elements and the engaging elements obtained from the primary elements are not particularly limited and are changeable. For example, the primary elements and the engaging elements may be arranged in a staggered pattern in which the primary elements or the engaging elements are positioned alternately or in a zigzag manner with the element rows that are adjacent to each other in the cross direction CD being shifted relative to each other in the machining direction MD by ½ of the pitch of the primary elements or engaging elements.

In the present embodiment, the primary elements 52 each include a primary stem portion 53, which has a circular truncated conical shape standing from the tentative base part 51; a stick-like rib portion 54, which is a portion of the upper surface of the primary stem portion 53 that is raised upward; and two projecting portions (primary pawl portions) 55, which are formed integrally with the rib portion 54 and project from two respective ends of the rib portion 54.

In the die wheel 11 according to the present embodiment, as described above, the outer peripheral edge of each of the through-holes 12a formed at the inner peripheral surface of the outer sleeve 12 includes a portion that overlaps at least one of the recessed groove portions 13a provided in the inner sleeve 13. Therefore, when molten synthetic resin is fed to the die wheel 11 in the primary molding step, the synthetic resin flows through the through-holes 12a of the outer sleeve 12 into the recessed groove portions 13a of the inner sleeve 13 and spreads therein, whereby the rib portion 54 and the projecting portions 55 of each of the primary elements 52 are molded. Hence, the rib portion 54 and the projecting portions 55 of each of the primary elements 52 are aligned in the cross direction CD (the direction in which the recessed groove portions 13a extend). Furthermore, in a plan view of the primary element 52, the projecting portions 55 each project outward relative to the upper end face of the primary stem portion 53.

In the primary molding step, the molten synthetic resin is carried by the outer peripheral surface of the die wheel 11 and undergoes half a turn while being cooled, whereby the above-described primary molded body 50 is molded. Subsequently, the primary molded body 50 is continuously peeled from the outer peripheral surface of the die wheel 11 by the pickup roller 16.

Then, the primary molded body 50 peeled from the die wheel 11 is transported toward the hot pressing device 20 configured to perform the secondary molding step and is introduced between the upper pressing roller 21 and the lower pressing roller 22 of the hot pressing device 20.

In the secondary molding step, the tentative base part 51 of the primary molded body 50 is supported from below by the lower pressing roller 22. Furthermore, at least the upper end portions of the primary elements 52 of the primary molded body 50 are heated to be softened and are pressed from above by the upper pressing roller 21. Thus, a pre-fastener body (secondary molded body) 60 such as the one illustrated in FIG. 7 is obtained, in which a plurality of engaging elements 72 are molded integrally with the upper surface of the tentative base part 51. In the present invention, the pre-fastener body is a molded body that is yet to undergo the stretching process and includes a base part (tentative base part) thicker than that of the surface fastener and a plurality of engaging elements.

The engaging elements 72 of the pre-fastener body 60 each include a stem portion 73, which has a substantially circular truncated conical shape standing from the tentative base part 51; an engaging head 74, which is formed integrally with the upper end portion of the stem portion 73; and two microsized pawl portions (engaging pawl portions) 75, which each project outward from the outer peripheral edge of the engaging head 74.

The engaging head 74 spreads over the entirety of the upper end portion (distal end portion) of the stem portion 73 and orthogonally to the thickness direction. In a plan view (not illustrated) of the engaging element 72 that is seen from above, the two pawl portions 75 each project in the cross direction CD from the engaging head 74. In the present invention, the shape and size of the engaging elements are not particularly limited. For example, factors such as the shape of the fastening head, the shape of the pawl portions, the number of the pawl portions, and the direction in which the pawl portions project from the engaging head may be changed to form the engaging elements. Furthermore, a single surface fastener may include engaging elements of different kinds with different shapes.

After the secondary molding step, the pre-fastener body 60 delivered from the hot pressing device 20 is transported to the stretching device 30 (see FIG. 1). At the stretching device 30, the pre-fastener body 60 is introduced from the feeding unit, which is not illustrated, into the stretching device 30 and is subjected to a heating treatment (heating step) that is performed by the heating roller, a stretching process (stretching step) that is performed between the heating roller and the stretching roller, and a relaxing treatment (relaxing step) that is performed after the stretching process, in that order.

Specifically, in the heating treatment, the pre-fastener body 60 is brought into contact with the roller surface of the heating roller, whereby the pre-fastener body 60 is heated to such a temperature as to be stretchable.

The pre-fastener body 60 having passed the heating roller is then subjected to the stretching process (uniaxial stretching process) in which the pre-fastener body 60 is stretched in the machining direction MD between the heating roller and the stretching roller that is rotating at a higher rotation speed than the heating roller. In the stretching process, the tentative base part 51 of the pre-fastener body 60 is stretched in the machining direction MD into a base part 71. Furthermore, in the stretching process, the base part 71 to be obtained has a thickness between the upper surface and the lower surface thereof that is smaller than the thickness between the upper surface and the lower surface of the tentative base part 51 obtained through the secondary molding step.

Furthermore, in the present embodiment, the concave portions in the transferred unevenness portions 56 formed in the upper surface of the tentative base part 51 tend to be stretched more in the above stretching process than regions of the tentative base part 51 where no transferred unevenness portions 56 are formed. Nevertheless, the transferred unevenness portions 56 according to the present embodiment each extend in a direction inclined at an inclination angle θ of 4° or greater with respect to the cross direction CD. Therefore, in each of the transferred unevenness portions 56 formed in the tentative base part 51, compared with a case where, for example, the transferred unevenness portions formed in the tentative base part each extend in the cross direction, the concentration of the stress (tensile force) to be applied to the transferred unevenness portions 56 in the stretching process is eased, which can suppress the local stretching and local thickness-dimension reduction in regions having the transferred unevenness portions 56.

Furthermore, in the above stretching process, although the concave portions formed in the upper surface of the tentative base part 51 before the stretching process tend to be stretched more than the regions of the tentative base part 51 where no transferred unevenness portions 56 are formed, since such a concave portion is actively stretched, a region around the concave portion is less likely to be stretched. Furthermore, the regions of the tentative base part 51 where no transferred unevenness portions 56 are formed are also stretched to have a reduced thickness. Therefore, after the stretching process, convex portions are formed near and on the front and rear sides of the concave portion, and such a convex portion on each of the front and rear sides is less noticeable. In such a case, since the transferred unevenness portions 56 according to the present embodiment each extend in a direction inclined at an inclination angle θ of 4° or greater with respect to the cross direction CD, the local thickness reduction at the concave portion and the extent of formation of the convex portion around the concave portion are lowered. Consequently, the difference in the dimensions between the concave portion and the convex portion is reduced.

In the present invention, the method, means, conditions, and other relevant factors of the stretching process are not particularly limited as long as the tentative base part of the pre-fastener body is thinned by being stretched in the machining direction MD.

After the above stretching process is performed, the relaxing treatment is performed on the surface fastener 70 including the base part 71 and the engaging elements 72. In the relaxing treatment, the surface fastener 70 is transported between the stretching roller and the relaxing roller, which rotates at a lower speed than the stretching roller, such that the tension to be applied to the surface fastener 70 is reduced. Thus, the shape of the surface fastener 70 is stabilized.

Subsequently, the surface fastener 70 having passed the relaxing roller is delivered to the outside from the discharging unit of the stretching device 30. The surface fastener 70 discharged from the stretching device 30 is wound into a roll by, for example, a collecting roller or the like and is collected. Alternatively, the surface fastener 70 may be collected after being transported from the stretching device 30 to a cutting unit, not illustrated, and being cut by the cutting unit into pieces each having a predetermined width dimension and/or length dimension.

Through the manufacturing method according to the present embodiment including the primary molding step, the secondary molding step, and the stretching step described above, the surface fastener 70 illustrated in FIG. 7 is obtained. The surface fastener 70 obtained through the manufacturing method according to the present embodiment includes the plurality of engaging elements 72 on the upper surface of the base part 71, which is in the form of a thin plate. Since the surface fastener 70 has been subjected to the stretching process performed in the machining direction MD, the base part 71 thereof has a smaller thickness than a typical surface fastener in the known art that is obtained without being subjected to the stretching process. For example, the base part 71 of the surface fastener 70 according to the present embodiment has a thickness dimension of 30 μm or greater and smaller than 90 μm, preferably 40 μm or greater and 80 μm or smaller. Therefore, the surface fastener 70 according to the present embodiment manufactured as above provides advantageous effects brought by the thinning of the base part 71: such as increased flexibility, a reduced weight, increased productivity, and a reduced manufacturing cost.

The surface fastener 70 according to the present embodiment is manufactured through the stretching process performed on the primary molded body 50 having the plurality of linear transferred unevenness portions 56. Instead, the transferred unevenness portions 56 each extend in a direction inclined at an inclination angle θ of 4° or greater with respect to the cross direction CD. Such a configuration effectively suppresses local stretching and local thickness-dimension reduction in regions having the transferred unevenness portions 56 that may occur when, as described above, the stretching process is performed.

Therefore, even if the base part 71 subjected to the stretching process as described above is thinned to have a thickness dimension smaller than 90 μm, the unevenness height difference between the concave portion and the convex portion included in each of the transferred unevenness portions 56 of the base part 71 is reduced to a small value of 20 μm or less. Consequently, the transferred unevenness portions 56 at the upper surface of the base part 71 become less noticeable to such an extent as to be difficult to identify in direct visual observation. Thus, the influence of the transferred unevenness portions 56 upon the appearance quality of the surface fastener 70 is reduced. Furthermore, the variations in the thickness dimension of the base part 71 and in the pitch of the engaging elements 72 that tend to occur in the length direction of the surface fastener 70 (the machining direction MD) are reduced. Consequently, the variation in the peel strength of the surface fastener 70 (particularly, the variation in the length direction) is reduced to a small value.

In the present invention, the unevenness height difference in the transferred unevenness portions and the unevenness height difference between the concave portion and the convex portion included in the transferred unevenness portions both refer to the difference in the up-down direction between the position, in the up-down direction, of the bottom of the concave portion and the position, in the up-down direction, of the top end portion of the convex portion adjacent to the concave portion included in a single transferred unevenness portion. The unevenness height difference in the transferred unevenness portions may be obtained by, for example, measuring the surface profile of the base part through a laser microscope.

In the above embodiment, the pre-fastener body 60 is made by performing the primary molding step with the use of the primary molding device 10 and the secondary molding step with the use of the hot pressing device 20. In the present invention, however, the method and means of molding a pre-fastener body are not particularly limited. In the present invention, for example, the pre-fastener body 60 may be made without performing the secondary molding step in which thermal deformation is caused as in the above example, but by performing a molding step with the use of a molding device having cavities with which the engaging elements 72 each including the stem portion 73 and the engaging head 74 are moldable.

### EXAMPLES

The present invention will further be described specifically, with working examples and comparative examples.

### Working Examples 1 to 8

Surface fasteners 70 were manufactured as Working Examples 1 to 8 by using the manufacturing apparatus 1 described in the above embodiment.

For each of Working Examples 1 to 8, the outer sleeve 12 included in the die wheel 11 was obtained from a thin plate member 18 made of stainless steel and having a thickness of 0.30 mm. To make such an outer sleeve 12 for each Working Example, the thin plate member 18 was first rolled into a circular cylindrical shape and was welded to have a welded part 12b extending at an inclination angle θ, summarized in Table 1 to be given below, with respect to the cross directions CD, whereby a circular cylinder was formed. Subsequently, a hole-making process was performed on the circular cylinder with an electron beam, whereby a plurality of through-holes 12a were made. Furthermore, a surface polishing process and a plating process were performed on the circular cylinder, whereby an outer sleeve 12 was obtained.

The inner sleeve 13 was obtained from a thin plate member having a thickness of 0.20 mm and made of a stainless steel that is softer than that for the outer sleeve 12. To make such an inner sleeve 13 for each Working Example, an etching process was first performed on the thin plate member, whereby a plurality of recessed groove portions 13a were provided. Subsequently, the thin plate member having the recessed groove portions 13a was rolled and was welded to have a welded part 13b extending at an inclination angle θ, summarized in Table 1 to be given below, with respect to the cross direction CD, whereby a circular cylinder was formed. Subsequently, a plating process was performed on the circular cylinder, whereby an inner sleeve 13 was obtained.

To attach the outer sleeve 12 and the inner sleeve 13 thus obtained to the rotatable driving roller 14 of the die wheel 11, the inner sleeve 13 was inserted into the outer sleeve 12, and the outer sleeve 12 and the inner sleeve 13 were fitted to each other such that the welded part 12b of the outer sleeve 12 and the welded part 13b of the inner sleeve 13 were located at 180° from each other.

Subsequently, while air was blown from the outer peripheral surface of the rotatable driving roller 14, the outer sleeve 12 and the inner sleeve 13 were moved in such a manner as to cover the rotatable driving roller 14. Subsequently, the air blown from the rotatable driving roller 14 was stopped, whereby the outer sleeve 12 and the inner sleeve 13 were fitted and secured to the rotatable driving roller 14 at a predetermined attaching position. Thus, a die wheel 11 including the outer sleeve 12 and the inner sleeve 13 having the welded parts 12b and 13b extending at respective inclination angles θ summarized in Table 1 was prepared.

Subsequently, the primary molding step was performed by using the primary molding device 10 including the die wheel 11 prepared as above, and the secondary molding step was performed by using the hot pressing device 20, whereby a pre-fastener body 60 including a tentative base part 51 having a thickness dimension of 90 μm was obtained. Furthermore, the stretching step was performed on the pre-fastener body 60 by using the stretching device 30. Thus, a surface fastener 70 was manufactured for each of Working Examples 1 to 8. In the stretching step, the stretching process was performed in the stretching device 30 under a condition that the pre-fastener body 60 heated to 140° C. was stretched to 150% in the machining direction MD between the heating roller and the stretching roller, whereby the thickness dimension (90 μm) of the tentative base part 51 was reduced, and a base part 71 having a thickness dimension of 60 μm was obtained.

Subsequently, to evaluate the surface fasteners 70 manufactured for Working Examples 1 to 8, each of the surface fasteners 70 was cut into a sample of the surface fastener 70 of 1-m long in the machining direction MD. Furthermore, the upper surface of the base part 71 of the sample was visually observed, and the number of visually identifiable transferred unevenness portions 56 was counted. Furthermore, the unevenness height difference in the transferred unevenness portions 56 formed in the base part 71 of the sample was measured through a laser microscope.

The unevenness height difference in the transferred unevenness portions 56 was measured for those transferred unevenness portions 56 attributed to the welded part 12b of the outer sleeve 12 and for those transferred unevenness portions 56 attributed to the welded part 13b of the inner sleeve 13. The laser microscope used in measuring the unevenness height difference was a profile-analyzing laser microscope VK-X250/VK-X260 from KEYENCE CORPORATION. This laser microscope was equipped with a lens having a magnification of 10 times. The profile of the upper surface of the base part 71 in an area of 10-mm long or greater in the machining direction MD was measured by combining different fields of view. Thus, the unevenness height difference in the transferred unevenness portions 56 was measured.

Furthermore, for comparison with the unevenness height difference in the transferred unevenness portions 56 of the surface fastener 70, the unevenness height difference in the transferred unevenness portions 56 formed in the tentative base part 51 of the pre-fastener body 60 yet to undergo the stretching step was also measured through the above laser microscope. The unevenness height difference in a case where convex portions were formed clearly was determined as the difference in the up-down direction between the lowest position in the concave portion and the highest position in the convex portions formed on the front and rear sides of the concave portion. The unevenness height difference in a case where convex portions were formed unclearly was determined as the difference in the up-down direction between the lowest position in the concave portion and regions of the upper surface of the base part 71 or the tentative base part 51 that were located on the front and rear sides of the concave portion.

The unevenness height difference in the transferred unevenness portions 56 was measured for each of the pre-fastener body 60 and the surface fastener 70, as summarized in Table 1 to be given below.

### Comparative Examples 1 and 2

Surface fasteners were manufactured as Comparative Examples 1 and 2, in each of which the inclination angles θ of the welded parts 12b and 13b in the outer sleeve 12 and the inner sleeve 13 with respect to the cross direction CD were set as summarized in Table 1 to be given below. Note that factors, excluding the inclination angles θ, of the surface fasteners manufactured as Comparative Examples 1 and 2 were the same as those of Working Examples 1 to 8. As with the case of Working examples 1 to 8, the unevenness height difference in the transferred unevenness portions was measured for each of the pre-fastener body and the surface fastener in each of Comparative Examples 1 and 2.

The unevenness height differences in the transferred unevenness portions measured for Comparative Examples 1 and 2 are summarized in Table 1 below.

TABLE 1

| | | | Unevenness height | | | | |
|---|---|---|---|---|---|---|---|
| | | | difference in | | Unevenness height | | |
| | | | transferred | | difference in | | |
| | | | unevenness | | transferred | | |
| | | | portions of pre- | | unevenness | | |
| | Inclination | | fastener body | | portions of surface | | |
| | angle θ of | | (before stretching | | fastener (after | | |
| | welded part | | process) | | stretching process) | | |
| | Outer | Inner | Outer | Inner | Outer | Inner | |
| | sleeve | sleeve | sleeve | sleeve | sleeve | sleeve | Visual |
| | Degree | Degree | μm | μm | μm | μm | observation |
| Working | 4 | 4 | 13.7 | 17.0 | 14.5 | 17.8 | 0 |
| Example 1 | | | | | | | |
| Working | 6 | 6 | 13.6 | 16.7 | 14.1 | 17.3 | 0 |
| Example 2 | | | | | | | |
| Working | 8 | 8 | 12.9 | 16.1 | 13.7 | 16.8 | 0 |
| Example 3 | | | | | | | |
| Working | 10 | 10 | 11.8 | 14.9 | 12.2 | 15.2 | 0 |
| Example 4 | | | | | | | |
| Working | 4 | 0 | 13.8 | 23.2 | 14.6 | 26.4 | 1 |
| Example 5 | | | | | | | |
| Working | 0 | 4 | 20.9 | 17.1 | 23.1 | 17.8 | 1 |
| Example 6 | | | | | | | |
| Working | 8 | 0 | 13.0 | 23.3 | 13.8 | 26.6 | 1 |
| Example 7 | | | | | | | |
| Working | 0 | 10 | 21.1 | 15.1 | 23.0 | 15.4 | 1 |
| Example 8 | | | | | | | |
| Comparative | 0 | 0 | 21.0 | 22.9 | 23.3 | 26.3 | 2 |
| Example 1 | | | | | | | |
| Comparative | 2 | 2 | 20.8 | 23.0 | 23.2 | 26.5 | 2 |
| Example 2 | | | | | | | |

Table 1 shows that the surface fastener 70 obtained after the stretching process tends to have a greater unevenness height difference in the transferred unevenness portions 56 than the pre-fastener body 60 obtained before the stretching process. Furthermore, in the surface fasteners 70 of Working Examples 1 to 8 in which the inclination angle θ of at least one of the welded part 12b of the outer sleeve 12 and the welded part 13b of the inner sleeve 13 was 4° or greater, it is found that the unevenness height difference in at least one of the transferred unevenness portions 56 formed in the base part 71 was smaller than in the surface fasteners of Comparative Examples 1 and 2 in which the inclination angle θ was smaller than 4°.

In particular, in the surface fasteners 70 of Working Examples 1 to 4 in which the inclination angle θ was set to 4° or greater for both of the welded parts 12b and 13b of the outer sleeve 12 and the inner sleeve 13, the unevenness height difference was smaller for each of the two transferred unevenness portions 56 formed by the welded parts 12b and 13b of the outer sleeve 12 and the inner sleeve 13.

Specifically, in the surface fasteners 70 of Working Examples 1 to 8, the unevenness height difference in the transferred unevenness portions 56 formed by the welded parts 12b and 13b that were at an inclination angle θ of 4° or greater was as small as 20 μm or less, particularly 18 μm or less, showing that the transferred unevenness portions 56 formed were of such sizes and shapes as to be difficult to identify in direct visual observation. In contrast, in Comparative Examples 1 and 2, the transferred unevenness portions formed in the surface fastener each had a large unevenness height difference of greater than 23 μm and were easily identifiable in visual observation. Thus, it has been found that Working Examples 1 to 8 (particularly Working Examples 1 to 4) each can produce less noticeable transferred unevenness portions 56 on the base part 71, providing a surface fastener 70 with excellent appearance quality.

Furthermore, comparing Working Examples 1 to 8 with each other, it has been found that increasing the inclination angle θ of the welded parts 12b and 13b further reduces the unevenness height difference in the transferred unevenness portions 56 formed in the base part 71 of the surface fastener 70 and also further reduces the variation between the unevenness height differences before and after the stretching process.

Furthermore, the transferred unevenness portion 56 formed by the welded part 13b of the inner sleeve 13 tended to have a greater unevenness height difference than the transferred unevenness portion 56 formed by the welded part 12b of the outer sleeve 12. The reason for this is considered as follows: the thickness (0.20 mm) of the inner sleeve 13 was smaller than the thickness (0.30 mm) of the outer sleeve 12; and the inner sleeve 13 was made of a softer metal than the outer sleeve 12. Consequently, the difference in the hardness of the inner sleeve 13 between the welded part 13b and the region excluding the welded part 13b was greater than in the outer sleeve 12. Therefore, the amount of deformation of the welded part 13b that occurred when the inner sleeve 13 was attached to the die wheel 11 (that is, when the inner sleeve 13 was inflated) is considered to have become greater than that of the welded part 12b of the outer sleeve 12.

### REFERENCE SIGNS LIST

1 manufacturing apparatus
10 primary molding device
11 die wheel
12 outer sleeve (outer cylinder)
12a through-hole
12b welded part
13 inner sleeve (inner cylinder)
13a recessed groove portion
13b welded part
14 rotatable driving roller
15 feeding nozzle
16 pickup roller
16a upper nipping roller
16b lower nipping roller
18 thin plate member
19 side
19a first-pair side
19b second-pair side
20 hot pressing device (secondary molding device)
21 upper pressing roller (calender roller)
22 lower pressing roller (calender roller)
30 stretching device
50 primary molded body
51 tentative base part
52 primary element (tentative element)
53 primary stem portion
54 rib portion
55 projecting portion (primary pawl portion)
56 transferred unevenness portion (transfer mark)
57 element row
60 pre-fastener body (secondary molded body)
70 surface fastener
71 base part
72 engaging element
73 stem portion
74 engaging head
75 pawl portion (engaging pawl portion)
CD cross direction
MD machining direction

1. A surface-fastener-manufacturing method of manufacturing a surface fastener made of synthetic resin and including a base part having a plurality of engaging elements, the method including at least a molding step of performing molding by feeding molten synthetic resin toward a die wheel that is rotating in one direction; and a stretching step of performing a stretching process in a machining direction after the molding step, wherein the manufacturing method comprises:
using the die wheel in the molding step, the die wheel including at least one sleeve having cavities with which the engaging elements or tentative elements to be deformed into the engaging elements are to be molded, the sleeve having a circular cylindrical shape and obtained from a metal thin plate member by bringing one end portion and an other end portion of the thin plate member in a first direction into contact with each other and joining the one end portion and the other end portion brought into contact with each other to each other by welding, the one end portion and the other end portion joined to each other forming a welded part, the welded part being inclined at an angle of 4° or greater with respect to a second direction, the second direction being orthogonal to the first direction and disposed along an axial direction of the sleeve.

2. The surface-fastener-manufacturing method according to claim 1, wherein
the sleeve includes an outer sleeve and an inner sleeve that is closely in contact with an inner peripheral surface of the outer sleeve,
the outer sleeve has a plurality of through-holes penetrating through the outer sleeve from an outer peripheral surface to the inner peripheral surface of the outer sleeve,
the inner sleeve has a plurality of recessed portions provided in an outer peripheral surface of the inner sleeve, and
an outer peripheral edge of at least one of the through-holes at the inner peripheral surface of the outer sleeve includes a portion that overlaps a recessed portion provided in the inner sleeve.

3. The surface-fastener-manufacturing method according to claim 1, wherein
the inner sleeve is made of a softer metal than the outer sleeve.

4. A surface fastener made of synthetic resin and including a base part and a plurality of engaging elements, the base part having a first surface and a second surface that face away from each other, the engaging elements projecting from the first surface of the base part, the base part being shaped as a thin plate that is elongated in a first direction, wherein
the base part has a thickness dimension between the first surface and the second surface of smaller than 90 μm,
the first surface of the base part has a transferred unevenness portion including a concave portion and a convex portion that are formed in the first surface,
the transferred unevenness portion is formed linearly along a direction inclined at an angle of 4° or greater with respect to a second direction that is orthogonal to the first direction, and
an unevenness height difference in the transferred unevenness portion is 20 μm or smaller.

5. A molding device to be used in manufacturing a surface fastener, the surface fastener being made of synthetic resin and including a base part having a plurality of engaging elements, the molding device including a die wheel configured to rotate in one direction; and a feeding nozzle configured to feed molten synthetic resin toward the die wheel, wherein
the die wheel includes at least one sleeve having cavities with which the engaging elements or tentative elements to be deformed into the engaging elements are to be molded,
the sleeve has a circular cylindrical shape and is obtained from a metal thin plate member by bringing one end portion and an other end portion of the thin plate member in a first direction into contact with each other and joining the one end portion and the other end portion brought into contact with each other to each other by welding, and
the one end portion and the other end portion joined to each other form a welded part, the welded part being inclined at an angle of 4° or greater with respect to a second direction, the second direction being orthogonal to the first direction and disposed along an axial direction of the sleeve.

6. The molding device according to claim 5, wherein
the sleeve includes an outer sleeve and an inner sleeve that is closely in contact with an inner peripheral surface of the outer sleeve,
the outer sleeve has a plurality of through-holes penetrating through the outer sleeve from an outer peripheral surface to the inner peripheral surface of the outer sleeve,
the inner sleeve has a plurality of recessed portions provided in an outer peripheral surface of the inner sleeve, and
an outer peripheral edge of at least one of the through-holes at the inner peripheral surface of the outer sleeve includes a portion that overlaps a recessed portion provided in the inner sleeve.

7. The molding device according to claim 5, wherein
the inner sleeve is made of a softer metal than the outer sleeve.
